(19) United States
(12) Patent Application Publication
(10) Pub. No.: US 2022/0119109 A1
(43) Pub. Date: Apr. 21, 2022

(54) THREE-DIMENSIONAL SHIELD TO PROTECT UNMANNED AERIAL VEHICLES FROM TREE BRANCHES AND OTHER SHARP OBJECTS

(71) Applicants: Sang Beom Lee, Harrison City, PA (US); Do Hyun Lee, Harrison City, PA (US); Brian Lee, Harrison City, PA (US)

(72) Inventors: Sang Beom Lee, Harrison City, PA (US); Do Hyun Lee, Harrison City, PA (US); Brian Lee, Harrison City, PA (US)

(21) Appl. No.: 17/506,775

(22) Filed: Oct. 21, 2021

Related U.S. Application Data
(60) Provisional application No. 63/094,599, filed on Oct. 21, 2020.

(51) Int. Cl. B64C 39/02; B64B 1/40

(52) U.S. Cl. CPC B64C 39/024; B64C 2201/027; B64B 1/40

(57) ABSTRACT

A protective shield to encompass an unmanned aerial vehicle or UAV includes an outer wall comprising a plurality of connected cells. Each of the cells comprising an extending passage having a length of at least 10 mm. An internal volume of the protective shield is sufficiently to encompass the UAV.

### CROSS-REFERENCE TO RELATED APPLICATIONS

This application claims benefit of U.S. Provisional Patent Application Ser. No. 63/094,599, filed Oct. 21, 2020, the disclosure of which is incorporated herein by reference.

### BACKGROUND

The following information is provided to assist the reader in understanding technologies disclosed below and the environment in which such technologies may typically be used. The terms used herein are not intended to be limited to any particular narrow interpretation unless clearly stated otherwise in this document. References set forth herein may facilitate understanding of the technologies or the background thereof. The disclosure of all references cited herein is incorporated by reference.

Unmanned aerial vehicles (UAVs) are instrumental for a variety of purposes. A popular form of UAV is the multicopter, a rotorcraft with more than two lift-generating rotors. An advantage of the multi-rotor aircraft is the simpler rotor mechanics required for flight control. As the technology of UAVs has improved and dramatically decreased in price, numerous applications have arisen, from recreational to military purposes such as surveillance, ambush detection, monitoring crop growth, or quickly transporting medicine to remote areas.

Multicopters lend themselves to a wide range of applications because of their advantages over other forms of UAVs. Multicopters use rotors for propulsion and control. Each rotor is essentially a fan with a spinning blade that pushes air down. All forces from the multi-rotors come in pairs, which means that as the rotor pushes down on the air, the air pushes up on the rotor. They are agile and operable in tight spaces, and significant hardware/software developments have been made in recent years: self-leveling, altitude hold, hover/position hold, headless mode, care-free, return-to-home, global positioning system (GPS) waypoint navigation, orbit around an object, and pre-programmed aerobatics.

Despite significant technical advances in both the areas of software and hardware, it is very challenging to develop a UAV shield that can adequately protect UAVs from a wide variety of obstacles such as trees, bushes, buildings, and manmade sharp structures. In that regard, multicopters and other UAVs often become entangled in trees, bushes etc. as a result of their unique design. Multiple rotors on the multicopter behave as hooks, which makes them vulnerable to entanglement in, for example, small tree branches and bushes. The development of a UAV protective shield equipped with an obstacle-resistance functionality to guard UAVs against trees/bushes and other obstacles is an important task for numerous applications. In certain applications, concealment may be important (for example, when UAVs conduct long-term surveillance operations or periodically charge their solar-powered battery for long trips). In addition, concealment is required when UAVs wait for ambush attacks in designated locations. To prevent entanglement, UAVs require an innovative protective shield that can assist them in escaping from obstacles while minimizing negative effect upon lift and maneuverability.

A number of devices or shields are currently available which purport to protect UAVs from obstacles. For example, a ball-shaped protective cages have been used in connection with ball drones. Such protective cages may protect the associated UAV from negative interaction with various obstacles but are not effective in protecting the UAV-shield assembly from becoming entangled in trees, bushes and in other spaces which may include extending element that may enter a shield and become entangled therewith. The diameter of tree branches, for example, often can be as small as 2 mm. Such branches can easily pass between essentially two-dimensional connecting components or beams on currently available shields to enter the shield and entangle the UAV-shield assembly (and potentially stop/damage the rotors of the UAV). Although the number of interconnecting beams for such shields can be increased (to decreasing the interstitial space therebetween), increasing the interconnecting beams of a shield dramatically increases the weight of the UAV-shield assembly. In addition, the air resistance/wind drag also increases as the number of beams increases. Weight and drag primarily determine battery consumption and flight time.

UAV protective shields are disclosed in, for example, U.S. Pat. Nos. 10,059,437, 9,145,207, 10,579,074, 4,795,111, 6,270,038, 7,032,861, 7,249,732, 7,712,701, 8,328,130, 9,004,973, 10,293,937, and 10,096,255. Although well-documented in design and operation, currently available UAV protective shield system are relatively easily entangled by tree branches, brushes and/or other entanglement risks. As set forth above, there is a critical need to develop UAV protective shield systems that can protect UAVs from engagement risks without significantly increasing drag.

### SUMMARY

Devices, system and methods hereof protect UAVs via a relative thick, deep, or three-dimensional wall thickness. UAVs within the shield devices or systems hereof are not easily entangled in tree branches, grass, bushes, man-made sharp objects or other structures with extending or projecting elements (for example, antennae, wiring/transmission systems etc.). By reducing or eliminating the risk of entanglement within such objects, the shield devices or systems hereof reduce the risk of damage or loss of UAVs and enhance the ability to pass close to or through space including various entanglement risks (which may, for example, provide improved flight paths and/or the opportunity for improved concealment). Concealment may, for example, be important when UAVs conduct surveillance for an extended time or when periodically charging a solar-powered battery system on long trips. In addition, concealment is required when UAVs wait for ambush attacks in designated locations.

In one aspect, a protective shield to encompass an unmanned aerial vehicle or UAV includes an outer wall comprising a plurality of connected cells. Each of the cells comprising an extending passage has a length of at least 10 mm. An internal volume of the protective shield is sufficiently to encompass the UAV. The protective shield further includes at least one interface via which the unmanned aerial vehicle is connected to the protective shield. The open nature of the cells provides little resistance to the lift created by the rotating blade(s) of the UAV, but the length or depth of such cells significantly reduces the likelihood of entanglement compared to currently available protective shields for UAVs. In a number of embodiments, the extending passages of the cells have a length or depth in the range of 10-200 mm, 10 to 100 mm or 20 to 60 mm.

Each of the cells may, for example, have an arced or a polygonal shape. In a number of embodiments, each of the cells has a, circular, a square, a hexagonal, a rectangular, or a triangular cross-sectional shape. In a number of embodiments, each of the cells has hexagonal shape.

The protective shield may, for example, be transparent or translucent. While translucent objects allow some light in the visible spectrum to pass therethrough, transparent objects allow most light to travel therethrough with little scattering. As used herein, the term transparent refers to materials that allow at least 85% of light transmission as determined, for example, using ASTM D-1003.

The protective shield hereof are adapted to display information thereon as a result of the length or depth of the cells. In a number of embodiments, the cells are formed from or coated with hydrophobic or super-hydrophobic materials. The cells may alternatively be formed from or coated with oleophobic or multiphobic (that is, both hydrophobic and oleophobic) materials. Using such coatings, the shield can potentially further protect the UAV from wetting by, for example, aqueous and/or other liquid (for example, when landing on or operating near the water).

The cells may, for example, have a width (average width) in range of 5 mm to 200 mm or 5 mm to 100 mm. The wall/cells may, for example, be formed from a polymeric material, a metallic material, a ceramic material, a wood material, or a combination thereof.

The protective shield wherein the interface is connected to the protective shield and includes one or more connectors to connect a UAV to the protective shield. In a number of embodiments, the interface includes a plurality of holders connected to the shield to which the UAV is connectible or an annular member to which the UAV is connectible.

In a number of embodiments, the protective shield includes a top section and a bottom section which are connectible to form the protective shield. In a number of embodiments, the top section and the bottom section are each connectible to an intermediate section.

The protective shield may, for example, further include at least one balloon or bladder filled with a gas having a density less than air. In a number of embodiments, the protective shield includes a doughnut-shaped balloon filled with a gas having a density less than air which is attached to and encompasses the outer wall.

In another aspect, a method of protecting an unmanned aerial vehicle or UAV includes encompassing the UAV in a protective shield comprising an outer wall comprising a plurality of connected cells, each of the cells comprising an extending passage having a length of at least 10 mm and at least one interface via which the unmanned aerial vehicle is connected to the protective shield. The protective shield may be further characterized as described above.

In still a further aspect, a method of fabricating a protective shield to encompass an unmanned aerial vehicle or UAV includes forming an outer wall comprising a plurality of connected cells, each of the cells comprising an extending passage having a length of at least 10 mm and at least one interface via which the unmanned aerial vehicle is connected to the protective shield.

The present devices, systems, and methods, along with the attributes and attendant advantages thereof, will best be appreciated and understood in view of the following detailed description taken in conjunction with the accompanying drawings.

### BRIEF DESCRIPTION OF THE DRAWINGS

FIG. 1A illustrates a top and a side, cutaway view of a currently available, essentially two-dimensional shield including connecting elements (or beams), wherein the top and bottom sections of the shield are generally dome shape.

FIG. 1B illustrates a top view and a side, cutaway view of the embodiment of a three-dimensional honeycomb UAV shield hereof, wherein the top and bottom sections are generally dome-shaped.

FIG. 2A illustrates how tree branches are easily caught and entangled/stuck in a portion of a currently available, ball-like UAV shield that includes relatively thin connecting elements or beams.

FIG. 2B illustrates that a UAV-shield assembly including an embodiment of a shield hereof can readily prevent entanglement and easily pass through tree branches and/or other spaces with potential entanglements even after contact of projecting elements such as tree branches with the UAV shield.

FIG. 3 illustrates top views of various shapes (circular, hexagonal or square) of the top and/or bottom sections of embodiments of UAV shields hereof, wherein individual cells in the section can be of various geometric such as arced/circular shapes or polygonal shapes (for example, hexagonal or honeycomb and/or square).

FIG. 4 illustrates a side view of an embodiment of a UAV shield hereof having a generally rectangular shape wherein the top and bottom sections have a generally flat outer surface and include individual cells of significant thickness.

FIG. 5A illustrates a top view of an embodiment of UAV holders or supports within an embodiment of a shield hereof without a UAV present within the shield.

FIG. 5B illustrates a top view of the holders or supports of FIG. 5A attached to a UAV.

FIG. 6A illustrates a top view of a UAV including rotors extending generally to the sides thereof.

FIG. 6B illustrates a top view of a UAV that include rotors extending generally to the front and back thereof.

FIG. 6C illustrates a top view of an embodiment of holders or supports in an embodiment of a UAV shield hereof wherein each holder or support can be moved independently to accommodate UAVs that have rotors in different locations.

FIG. 7A illustrates a top perspective view of a UAV holder hereof that includes an annular or ring-shaped holder and a supporting structure therefor.

FIG. 7B illustrates a top perspective view of the ring-shaped holder of FIG. 7A that in which a UAV can be supported in any direction rotated about the ring.

FIG. 7C illustrates a top perspective view of supporting structure for the ring of FIG. 7A.

FIG. 7D illustrates a top view of UAV holders within an embodiment of a shield hereof without the presence of a UAV within the shield.

FIG. 7E illustrates a side view of UAV holders within an embodiment of a shield hereof without the presence of a UAV within the shield.

FIG. 7F illustrates a side view of the holders of FIG. 7E attached to a UAV.

FIG. 7G illustrates a top view of a UAV that sits on the holders of FIG. 7D.

FIG. 7H illustrates a top view of UAV. A UAV can sit any directions due to the ring structure of FIG. 7A. The holder can accommodate UAVs that have rotors in different locations.

FIG. 7I illustrates a top view of a UAV that is attached to a UAV shield.

FIG. 7J illustrates a side view of a UAV that is attached to a UAV shield.

FIG. 8A illustrates assembly of the top and bottom sections and an intermediate, frame or body section of an embodiment of a UAV shield hereof including the UAV holders or supports of FIG. 6C.

FIG. 8B illustrates assembly of the top and bottom sections and an intermediate, frame or body section of an embodiment of a UAV shield hereof including the UAV support assembly of FIG. 7A.

FIG. 9A illustrates an embodiment of an inflatable balloon/bladder hereof which may be filled with a gas which may have a density less than that of air.

FIG. 9B illustrates an embodiment of a UAV shield hereof that is placed in operative connection with (for example, enclosed or at least partially enclosed within) the inflatable balloon/bladder of FIG. 9A.

### DETAILED DESCRIPTION

It will be readily understood that the components of this system may be arranged and designed in a wide variety of different configurations in addition to the described representative embodiments. Thus, the following more detailed description of the representative embodiments, as illustrated in the figures, is not intended to limit the scope of this system, as claimed, but is merely illustrative of the system.

Reference throughout this specification to “one embodiment” or “an embodiment” (or the like) means that a feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well-known structures, materials, or operations are not shown or described in detail to avoid obfuscation.

As used herein and in the appended claims, the singular forms “a”, “an”, and “the” include plural references unless the context clearly dictates otherwise. Thus, for example, reference to “a cell” includes a plurality of such cells and equivalents thereof known to those skilled in the art, and so forth, and reference to “the cell” is a reference to one or more such cells and equivalents thereof known to those skilled in the art, and so forth. Recitation of ranges of values herein are merely intended to serve as a shorthand method of referring individually to each separate value falling within the range. Unless otherwise indicated herein, and each separate value, as well as intermediate ranges, are incorporated into the specification as if individually recited herein. All methods described herein can be performed in any suitable order unless otherwise indicated herein or otherwise clearly contraindicated by the text.

In a number of embodiments hereof, innovative UAV protective shield devices or systems (shields) have a three-dimensional structure wherein individual cells of the shield have significant depth. In a number of such embodiments, shields hereof have a honeycomb-like structure which includes repeating, three-dimensional hexagonal cells. Such a conformation creates partitions with equal-area/volume cells while minimizing the surface area of the cells. Because surface area is proportional to the quantity of material, the hexagonal cell structure uses the least material to create a lattice of cells with a given volume.

A honeycomb or hexagonal pattern or geometry fills a volume or space with a minimum of wasted volume. Spheres, for example, leave space between cells, while cubes do not optimize the volume and surface area ratio. In natural honeycombs produced by bees, wax cell walls may, for example, be only 0.05 mm thick. However, each cell can support 25 times its weight. A 100 gr honeycomb can, for example, hold up to 4 kg of honey. Bees have evolved to use the hexagonal or honeycomb geometry to efficiently store honey. Honeycomb or hexagonal structures are also often used in airplane wings and satellite walls because of their strength per unit weight.

In a number of embodiments, honeycomb (hexagonal) or other UAV shields hereof may, for example, be manufactured with additive manufacturing (AM) or three-dimensional (3-D) printing to construct the three-dimensional UAV shield. Plastic, ceramic, or metallic materials may, for example, be melted by heat or lasers of AM equipment, subsequently passing through an instant free-flow liquid phase, before they are solidified. AM offers precision and flexibility by creating components through layer-by-layer deposition from a three-dimensional computer aid design (CAD) model. AM equipment can create a wide range of components with a variety of materials.

Three-dimensional protective shields hereof have sufficient wall thickness such that the UAV-shield system or assembly disengages readily after contacting obstacles including projecting elements (whether linearly projecting or branched) such as tree and bushes. Using the shield devices or systems hereof, UAVs may, for example, readily pass through or remain within wooded areas, bushes or other areas traditionally presenting a high risk of entanglement without entanglement. Additionally, shields hereof have significant mechanical strength with minimal weight and air resistance.

UAV shields hereof allow the UAV to come into contact with obstacles and pass through such obstacles under the UAV's power as a result of an innovative obstacle releasing functionality provided by the three-dimensional shield wall structure. As described above, a honeycomb or hexagonal pattern may be used in a number of embodiments to maximize volume and minimizes material, resulting in a lightweight structure with the significant strength. Shield hereof protect UAVs from, for example, the branches of small tree or bushes in wooded areas and facilitate passage of UAVs therethrough or concealment of UAVs therein.

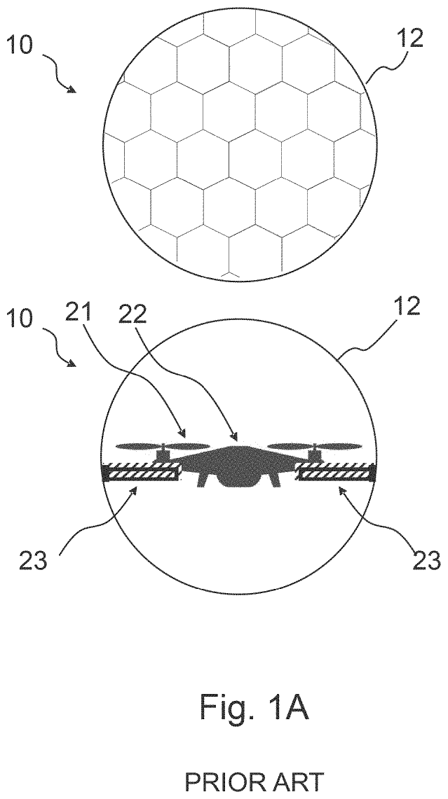

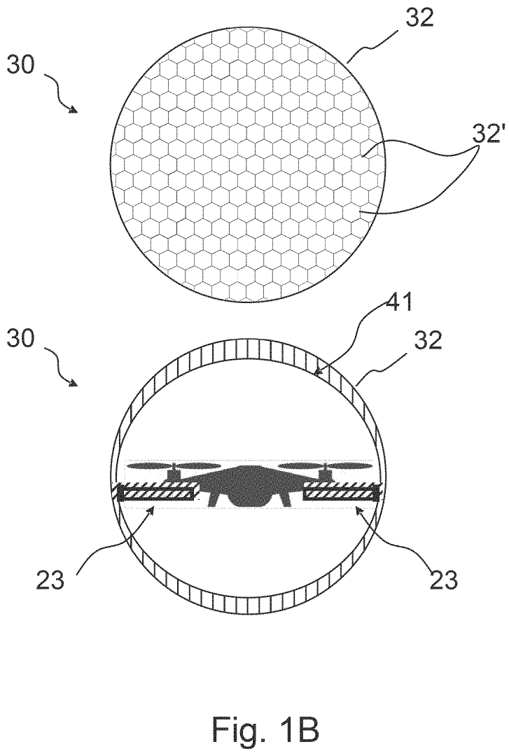

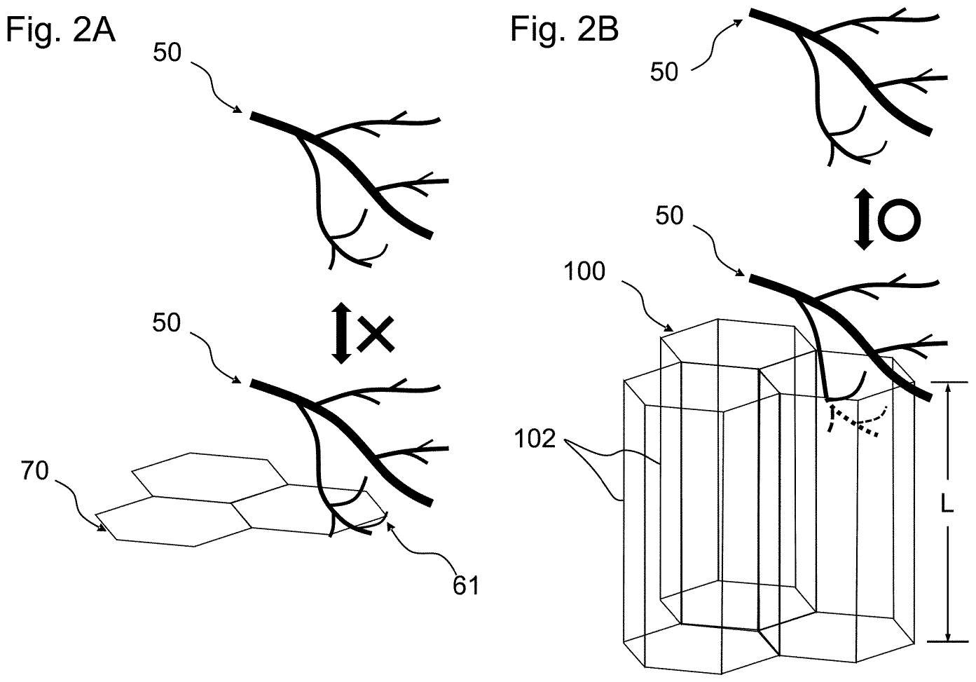

FIG. 1A shows the structure of a well-known ball-like UAV protective cage that includes connecting beams. Shield (10) of FIG. 1A is essentially two-dimensional. In that regard, the wall of shield (10) of FIG. 1A is very thin (that is, in the range of 2 mm to 3 mm). The thin wall of shield (10) can easily become entangled with obstacles such as tree branches, grass, and relatively thin extending man-made objects. In the shields hereof, however, the shield wall is formed of three-dimensional cells (that is, cells having significant depth). For example, such cells (or the conduits or passages defined thereby) may have a depth or length L (see FIG. 2B) in the range of 10-200 mm, 10 to 100 mm or 20 to 60 mm. FIG. 1B illustrates a representative embodiment of a three-dimensional UAV shield (30) hereof. Because individual cells of shield (30) hereof have significant depth, unlike the essentially two-dimensional wall structures formed from relatively thin connecting beams such as in shield (10), small tree branches and/or other relatively small projecting elements do not easily penetrate the cells of shield (30) to entangle shield (30).

The top view of the top or upper section or lid (12) in the upper section of FIG. 1A is similar in appearance to the top view of the top or upper section (32) of shield (30) hereof in the upper section of FIG. 1B. Although the top views of both upper sections (12 and 32) look similar, side, cutaway views in the lower sections of each of FIGS. 1A and 1B appear very different. The side, cutaway view of shield (10) appears as a circle. However, the side view of shield (30) hereof clearly shows the three-dimensional nature or depth of the wall. Each open, individual cell (32′) of upper section 32 has significant depth as described above.

The walls between each cell in the shields hereof (and particularly shields with hexagonal extending cells) can be fabricated very thinly by, for example, additive manufacturing or AM as described. Depending on the material of the shield, the desired use of the UAV-shield assembly and the lift power of the UAV, in a number of embodiments, the wall thickness of the cells may be in the range of 0.5 mm to 10 mm. In general, the thinner the walls, the better. The walls of the open cells may be very thin and oriented generally parallel to thrust of the UAV. The cells may, for example, be oriented vertically in the orientation illustrated in FIG. 1B. The cells may alternatively be oriented to align generally with the center of the generally spherical shield. The extending cell structure may, for example, improve performance in the wind because it guides airflow (like lengthening the barrel of a gun). The surface of the shields hereof can be colored/painted with a wide variety of colors for camouflage or to set forth information (for example, ads, warnings etc.), which cannot be readily achieved with relatively thin, essentially two-dimensional UAV protective structures.

FIGS. 2A and 2B illustrate in further detail the obstacle-releasing advantages provided by the UAV protective shields hereof using an example of a tree branch (50). FIG. 2A illustrates an essentially two-dimensional protective shield including a shield wall (70) including relatively thin connective elements or beams that can easily become entangled with projecting element of various obstacles. FIG. 2A demonstrates that a penetrating tree branch (61) cannot easily be removed from penetrating connection/entanglement with shallow-depth wall (70). As illustrated in FIG. 2B, on the other hand, tree branch (50) can be inserted into the open volume (extending conduit or passage) of an individual cell (102) of a three-dimensional shield wall (100) hereof but will not be caught or entangled because the length or depth L of each cell (102) prevents tree branch (50) from passing into the interior of shield wall (100) (that is, completely through a cell (102)).

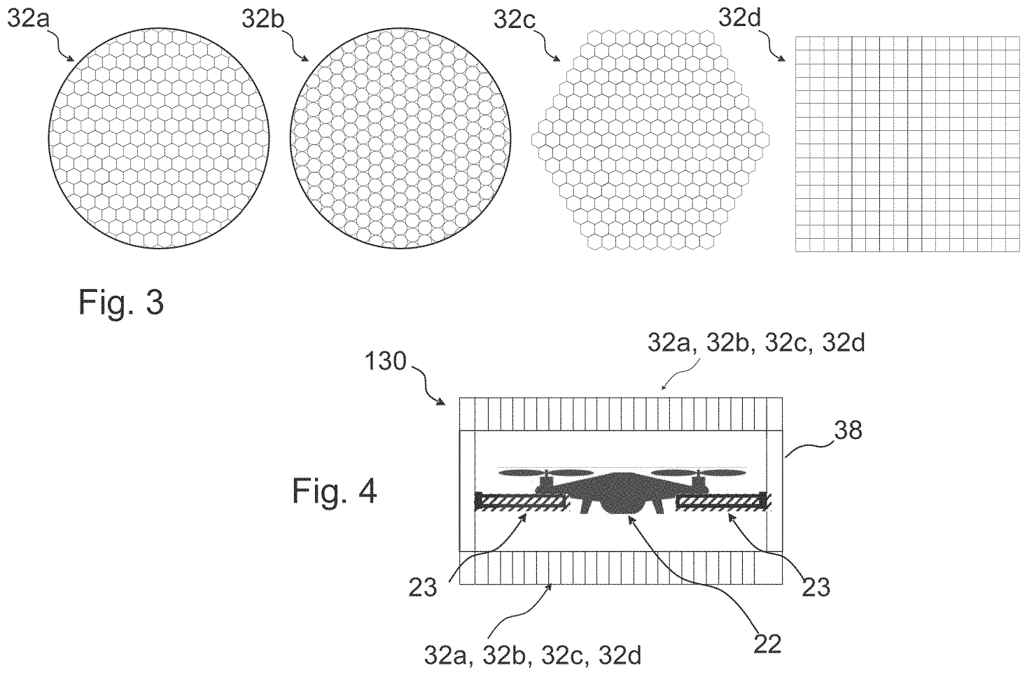

In a number of embodiments, shields hereof may be formed to include a top section and a bottom section which are connectible to encompass a UAV. The top section and the bottom section may be directly connectible or may be connectible to an intermediate or lateral section, frame or body. The shape of the top and bottom sections can vary. FIG. 3, for example, illustrates top views of representative bottom/top section designs. For example, top/bottom section (32a) is circular, but each cell has a three-dimensional hexagonal or honeycomb structure (that is, the perimeter or cross-section thereof is hexagonal). Top/bottom section (32b) is circular with circular cells. Top/bottom section (32c) is a hexagonal in overall shape and each cell is also a hexagonal or honeycomb structure. Top/bottom section (32d) is square, and each cell is also a three-dimensional square.

A spherical or ball-shaped shield shape hereof is described, for example, in connection with FIG. 1B. However, many other shapes are possible. For example, FIG. 4 illustrates a side, cutaway view of an embodiment of a UAV shield (130) hereof when top and bottom sections (32a, 32b, 32c, 32d) are relatively flat rather than domes and may have a perimeter that is designed/shaped as illustrated in FIG. 3. Top and bottom sections are connected to form UAV shield (130) via an intermediate of frame section (38) in the embodiment of FIG. 4.

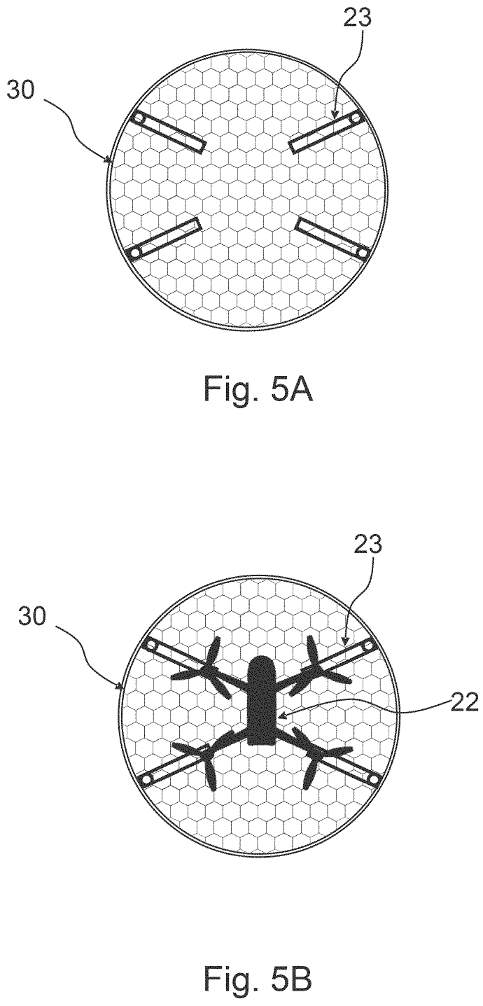

As described above, minimizing weight and air resistance of the UAV shield is important to the lift and flight time of UAVs. FIG. 5A illustrates the top view of a shield (30) hereof that includes a plurality of (four in the illustrated embodiment) holders or supports (23) wherein no UAV is within shield (30). FIG. 5B illustrates UAV (22) attached within shield (30) via holders (23) which extend from the outer wall of shield (30) (for example, from an intermediate or frame section thereof) to connect with UAV (22). Holders (23) are not interconnected, leaving the center of shield (30) unoccupied as illustrated in FIG. 5A. The design illustrated in FIGS. 5A and 5B assists in minimizing both weight and air resistance as a result of use of less material.

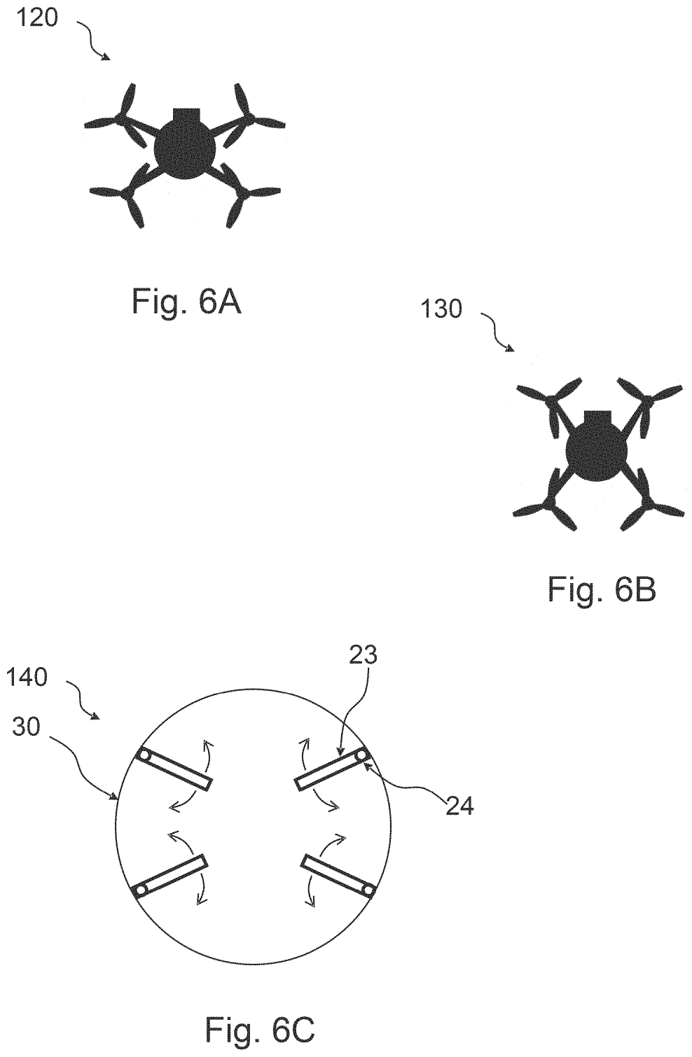

There are several different commercially available UAV body designs. For example, FIG. 6A illustrates a top view of a UAV body design that includes propellers extending primarily to the sides thereof (left and right in the illustrated embodiment). On the other hand, FIG. 6B illustrates a top view of a UAV body design that includes propellers extending primarily forward and backward. To accommodate such different body designs, shields 30 hereof (see, FIG. 6C) may include adjustable (for example, pivotable or hingeable) holders (140) attached, for example, to the wall thereof (for example, to the wall of the intermediate of frame section thereof). In this way, each holder can freely and independently move to extend to and connect to different UAV body structures such as those illustrated in FIGS. 6A and 6B.

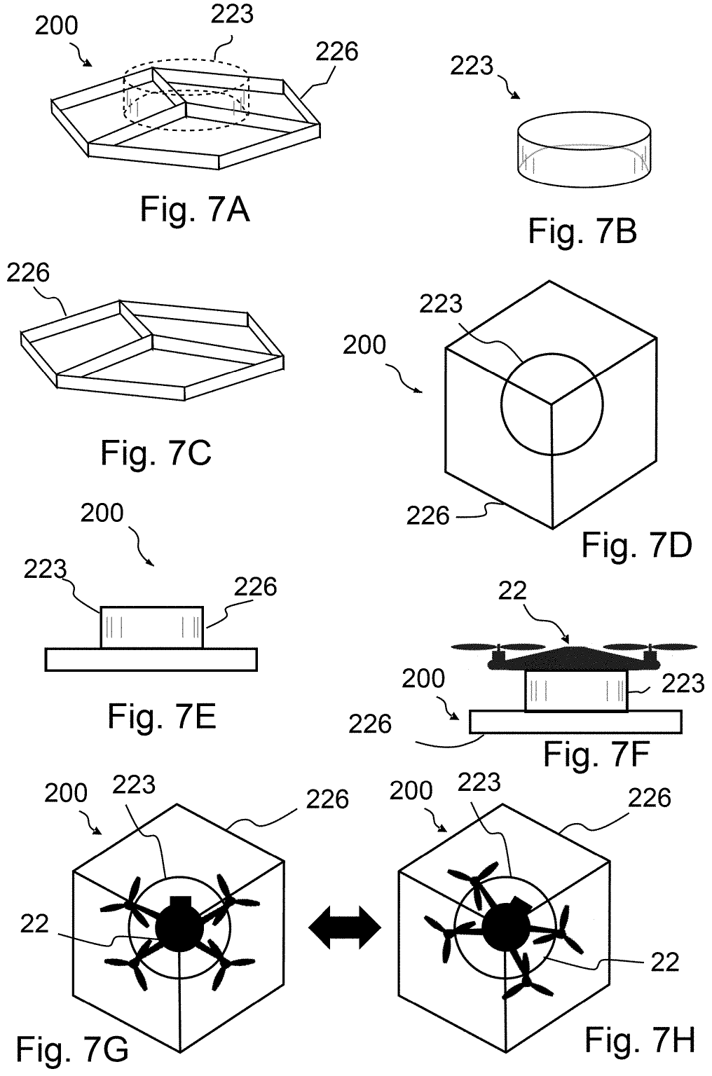

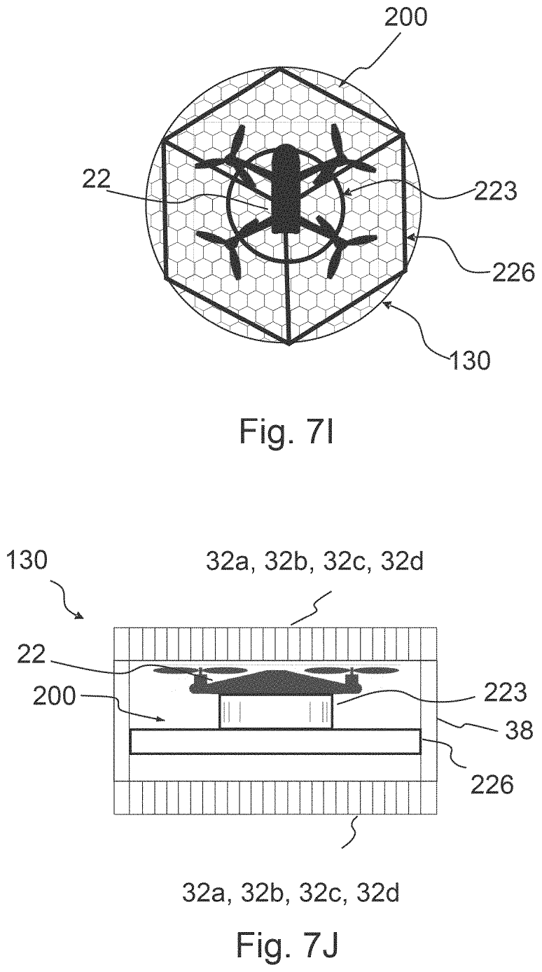

In certain embodiments, it is desirable that a UAV should be able to be seated within the shield to face in any direction in additions to being relatively easy to attach to and detach from the shield. An embodiment of a UAV support assembly (200) hereof including with a ring-shaped or annular UAV interface (223) is illustrated in FIG. 7A through 7J. Ring-shaped UAV interface is supported by a support or base (226) of support assembly (200) which may be attached at its perimeter to a UAV shield such as UAV shield (130) (for example, to intermediate section of frame (38) thereof) as illustrated in FIGS. 7I and 7J. Ring-shaped or annular interface (223) may, for example, include passages, loops etc. to attached one or more connectors thereto to secure UAV (22) thereto. Interface (223) can accommodate UAVs that have rotors extending in any locations around the body of the UAV and can accommodate UAVs of many different body designs. A UAV can be freely and rotatably positioned within a shield including a support such as support assembly (200) to any orientation before securely attached the UAV to interface (223). In addition, ring-shaped interface (223) can accommodate UAVs of differing size.

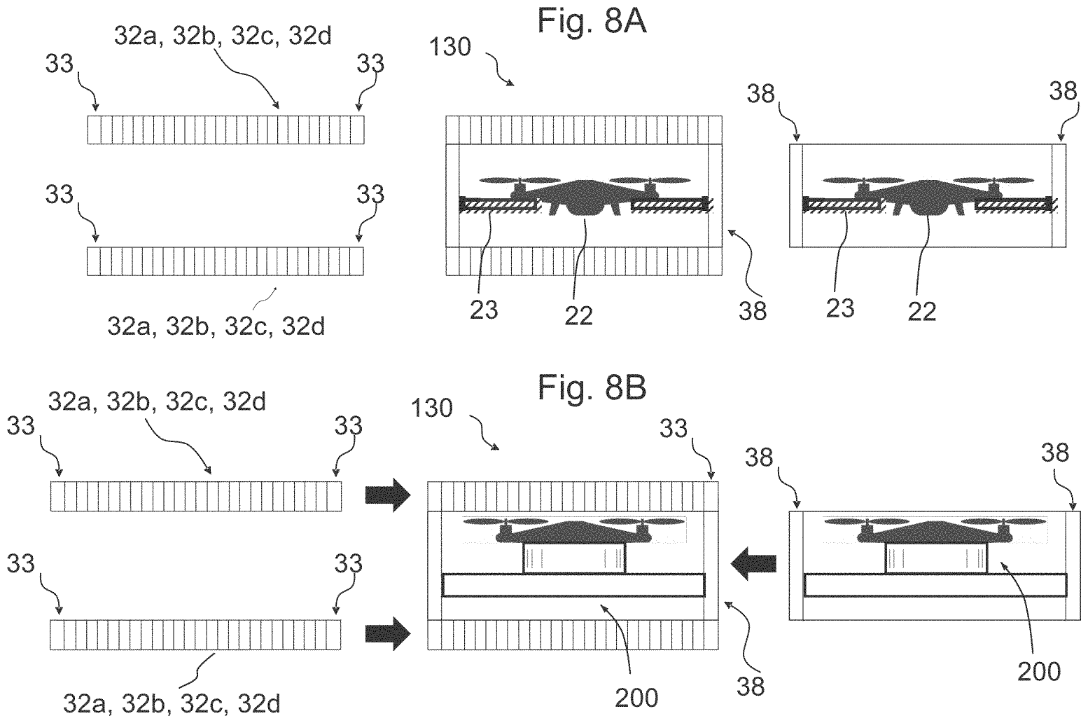

FIGS. 8A and 8B illustrates the assembly of the top and bottom sections (32a, 32b, 32c, 32d) and intermediate section, frame or body (38). After assembly, the top view of the UAV shield (130) would be the same as the top view of the top section (32a, 32b, 32c, 32d) as illustrated in FIG. 3. Top and bottom sections (32a, 32b, 32c, 32d) may, for example, include connectors (33) that from a connection with cooperating connectors (not shown) of intermediate section, frame or body (38) to form UAV shield (130).

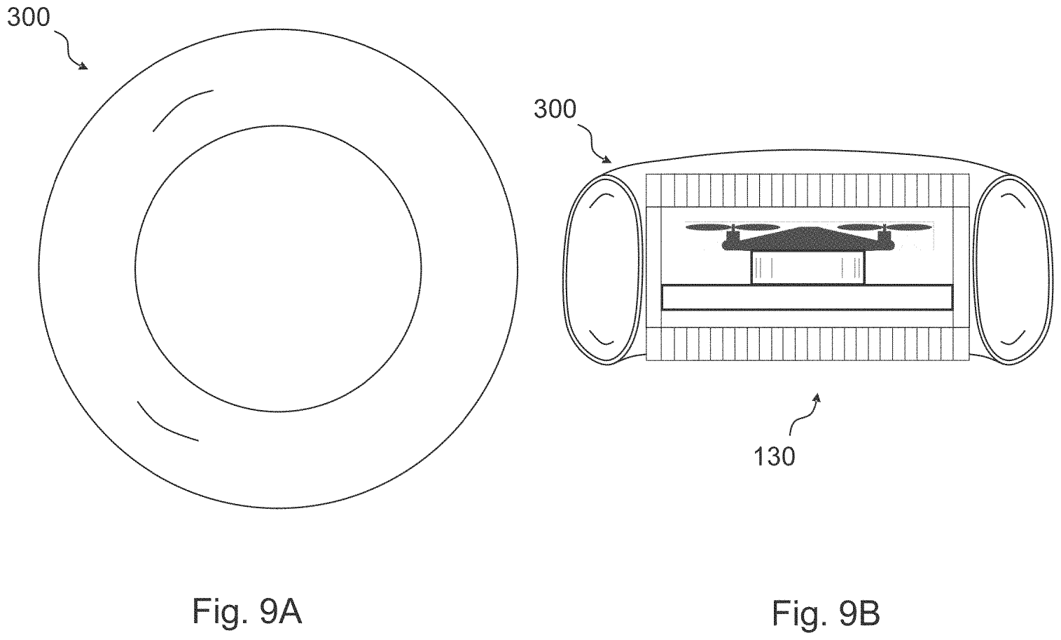

One of the important aspects of UAV development is the control of the weight of the UAV. Materials choice for constructing UAVs plays an important role in controlling weight. Currently, carbon fiber is a popular choice as it is both mechanically strong and lightweight. However, it remains very desirable to further reduce the weight of UAVs. In a number of embodiments hereof, an annular, ring-shaped or doughnut-shape bladder or balloon (300) is filled with lifting gases such as hydrogen, helium, or a combination of such gases, as illustrated in FIGS. 9A and 9B. In general, a lifting gas is a gas having a density less than air. Doughnut-shape balloon (300) wraps around or encompasses the UAV/UAV shield assembly hereof (for example, encompassing intermediate or frame section (38) of UAV shield (130). Because of the unique doughnut-shape of balloon (300), the aerodynamics of the UAV are not significantly affected by balloon (300), but the flight time of the UAV may be increased by the presence of balloon (300) which decreases the effective density (weight/displacement volume) of the total assembly.

The foregoing description and accompanying drawings set forth a number of representative embodiments at the present time. Various modifications, additions, and alternative designs will, of course, become apparent to those skilled in the art in light of the foregoing teachings without departing from the scope hereof, which is indicated by the following claims rather than by the foregoing description. All changes and variations that fall within the meaning and range of the equivalency of the claims are to be embraced within their scope.

What is claimed is:

1. A protective shield to encompass an unmanned aerial vehicle or UAV, comprising: an outer wall comprising a plurality of connected cells, each of the cells comprising an extending passage having a length of at least 10 mm, and at least one interface via which the unmanned aerial vehicle is connected to the protective shield.

2. The protective shield of claim 1 wherein the extending passages of the cells have a length in the range of 10-200 mm.

3. The protective shield of claim 1 wherein the extending passages of the cells have a length in the range of 10 to 100 mm.

4. The protective shield of claim 1 wherein each of the cells has a hexagonal cross-sectional shape.

5. The protective shield of claim 1 wherein each of the cells has an arced or a polygonal shape.

6. The protective shield of claim 1 wherein each of the cells has a circular, a square, a rectangular, a hexagonal, or a triangular cross-sectional shape.

7. The protective shield of claim 1 wherein the protective shield is transparent or translucent.

8. The protective shield of claim 1 wherein the cells are adapted to display information.

9. The protective shield of claim 1 wherein the cells are formed from or coated with hydrophobic or super-hydrophobic materials.

10. The protective shield of claim 1 wherein the cells have a width in range of from 5 mm to 200 mm.

11. The protective shield of claim 1 wherein the cells have a width in range of from 5 mm to 100 mm.

12. The protective shield of claim 1 wherein the cells are formed from a polymeric material, a metallic material, a ceramic material, a wood material or a combination thereof.

13. The protective shield of claim 1 wherein the at least one interface is connected to the protective shield and comprises one or more connectors to connect the UAV to the protective shield.

14. The protective shield of claim 13 wherein the at least one interface comprises a plurality of holders connected to the protective shield to which the UAV is connectible or an annular member to which the UAV is connectible.

15. The protective shield of claim 1 wherein the protective shield comprise a top section and a bottom section which are connectible to form the shield.

16. The protective shield of claim 15 wherein the top section and the bottom section are connectible to an intermediate section.

17. The protective shield of claim 1 further comprising at least one balloon filled with a gas having a density less than air.

18. The protective shield of claim 1 further comprising a doughnut-shaped balloon filled with a gas having a density less than air which is attached to and encompasses the outer wall.

19. A method of protecting a unmanned aerial vehicle or UAV, comprising: encompassing the UAV in a protective shield comprising an outer wall comprising a plurality of connected cells, each of the cells comprising an extending passage having a length of at least 10 mm and at least one interface via which the unmanned aerial vehicle is connected to the protective shield.

20. A method of fabricating a protective shield to encompass an unmanned aerial vehicle or UAV, comprising: forming an outer wall comprising a plurality of connected cells, each of the cells comprising an extending passage having a length of at least 10 mm and at least one interface via which the unmanned aerial vehicle is connected to the protective shield.
